(19) United States
(12) Patent Application Publication
(10) Pub. No.: US 2009/0005487 A1
(43) Pub. Date: Jan. 1, 2009

(54) Composite material composition and molded article thereof

(75) Inventor: Hiroyuki Nakagawa, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/213,900

(22) Filed: Jun. 26, 2008

(30) Foreign Application Priority Data
Jun. 27, 2007 (JP) 2007-169774

(51) Int. Cl. C08K 3/00; C08L 33/02; C08K 3/26

(52) U.S. Cl. 524/427; 524/522; 524/451; 524/449

(57) ABSTRACT

A composite material composition comprising 50 to 95% by weight of a micro body of an inorganic compound such as calcium carbonate, 0.1 to 30% by weight of a maleic anhydride-modified ethylene-butene copolymer rubber, and 1 to 48% by weight of a polypropylene resin. In addition, a molded article formed by molding the composite material composition.

### BACKGROUND OF THE INVENTION

1. Field of the Invention

The present invention relates to a composite material composition comprising an inorganic compound and a resin as well as a molded article comprising the composite material composition.

2. Related Art

Hitherto, in order to improve stiffness of a molded article comprising a thermoplastic resin such as polypropylene, an inorganic filler such as talc is sometimes added to the thermoplastic resin.

However, since an inorganic filler generally has a poor affinity to a thermoplastic resin such as polypropylene, the addition of the inorganic filler invites decrease in impact strength and the like of the molded article.

Thus, as described in JP-A-7-278378, JP-A-2000-143872 and Non-Patent Document: “Journal of Applied Polymer-Science”, 1996, vol. 61, p. 1877-1885, it is known to add a polymer (polypropylene or an elastic body) having a carboxyl group as a modifying group so as to improve affinity of the inorganic filler to the thermoplastic resin.

Nonetheless, it is generally considered that, even when an inorganic filler is added in an amount more than a certain amount, it is not expected to improve stiffness of the molded article any more and also the addition lowers impact strength and the like as well as it is considered that it is difficult to homogeneously mix a large amount of the inorganic filler with a small amount of the resin. Accordingly, there are only described those containing a smaller amount of an inorganic filler (about 1 to 70% by weight, and 5% by weight, 15% by weight, and 30% by weight in Examples) and a larger amount of a resin, in JP-A-7-278378, JP-A-2000-143872 and the Non-Patent Document.

### SUMMARY OF THE INVENTION

An object of the invention is to provide a composite material composition which secures a high stiffness and also has a sufficient impact strength through increasing a mixing amount of an inorganic compound as well as a molded article comprising the composite material composition.

### A. Composite Material Composition

The composite material composition of the invention comprises 50 to 95% by weight of a micro body of an inorganic compound, 0.1 to 30% by weight of a modified ethylene-butene copolymer rubber that is an unsaturated dicarboxylic acid-modified ethylene-butene copolymer rubber or an unsaturated dicarboxylic acid anhydride-modified ethylene-butene copolymer, and 1 to 48% by weight of a polypropylene resin.

Moreover, the composite material composition of the invention is formed by mixing the above raw material components and preferred is one wherein the micro body of the above inorganic compound is surrounded by a mixture of the above modified ethylene-butene copolymer rubber and the above polypropylene resin.

Furthermore, the composite material composition of the invention may contain an alicyclic hydrocarbon resin, may contain a modified polypropylene resin that is an unsaturated dicarboxylic acid-modified polypropylene resin or an unsaturated dicarboxylic acid anhydride-modified polypropylene resin, may contain both of the above alicyclic hydrocarbon resin and the above modified polypropylene resin, or may not contain both of them.

### B. Molded Article

The molded article of the invention comprises the above composite material composition.

The following will exemplify embodiments of individual elements in the invention.

### 1. Inorganic Compound

The inorganic compound is not particularly limited but examples thereof may include natural minerals such as calcium carbonate, talc, mica, wollastonite, silica, and clay. Preferred is at least one of calcium carbonate, talc, mica, and wollastonite. In this connection, the inorganic compound may be not only a natural mineral but also an artificially synthesized one.

The shape of the micro body of the inorganic compound is not particularly limited but examples thereof may include spherical, columnar, needle-like, flake-like ones and the like. The length of the longest part thereof is preferably 90 μm or less, more preferably 50 μm or less.

### 2. Modified Ethylene-Butene Copolymer Rubber

The amount for modification is not particularly limited but is preferably from 0.5 to 3% by weight. The glass transition temperature (Tg) is not particularly limited but is preferably from −70 to −50° C.

### 2-1. Unsaturated Dicarboxylic Acid-Modified Ethylene-Butene Copolymer Rubber

The unsaturated dicarboxylic acid-modified ethylene-butene copolymer rubber is not particularly limited but examples thereof may include maleic acid-modified, itaconic acid-modified ones and the like. Preferred is a maleic acid-modified ethylene-butene copolymer rubber.

### 2-2. Unsaturated Dicarboxylic Acid Anhydride-Modified Ethylene-Butene Copolymer Rubber

The unsaturated dicarboxylic acid anhydride-modified ethylene-butene copolymer rubber is not particularly limited but examples thereof may include maleic anhydride-modified, itaconic anhydride-modified ones and the like. Preferred is a maleic anhydride-modified ethylene-butene copolymer rubber.

### 3. Polypropylene Resin

Melt flow rate (MFR: at 230° C., 2.16 kgf (21.18N)) is not particularly limited but is preferably from 20 to 150 g/10 minutes in the case of the use as a composite material composition for injection molding and is preferably from 1 to 60 g/10 minutes in the case of the use as a composite material composition for extrusion molding.

### 4. Alicyclic Hydrocarbon Resin

The mixing amount of the alicyclic hydrocarbon resin in the case where it is contained in the composite material composition is not particularly limited but is preferably from 0.1 to 20% by weight. Moreover, softening point is not particularly limited but is preferably from 60 to 150° C.

### 5. Modified Polypropylene Resin

The mixing amount thereof in the case where it is contained in the composite material composition is not particularly limited but is preferably from 0.1 to 10% by weight. Moreover, the amount for modification is not particularly limited but is preferably from 0.5 to 3% by weight. Melting point (Tm) is not particularly limited but is preferably from 150 to 170° C. Melt flow rate (MFR: at 230° C., 2.16 kgf (21.18N)) is not particularly limited but is preferably from 1 to 100 g/10 minutes.

### 5-1. Unsaturated Dicarboxylic Acid-Modified Polypropylene Resin

The unsaturated dicarboxylic acid-modified polypropylene resin is not particularly limited but examples thereof may include maleic acid-modified, itaconic acid-modified ones and the like. Preferred is a maleic acid-modified propylene resin.

### 5-2. Unsaturated Dicarboxylic Acid Anhydride-Modified Polypropylene Resin

The unsaturated dicarboxylic acid anhydride-modified polypropylene resin is not particularly limited but examples thereof may include maleic anhydride-modified, itaconic anhydride-modified ones and the like. Preferred is a maleic anhydride-modified propylene resin.

### 6. Molded Article

The molded article is not particularly limited but examples thereof may include the following:

instrument panels, pillar trims, center consoles, and the like that are interior products of automobiles;

bumpers, side moldings, and the like that are exterior products of automobiles; and

cases for electronic devices, and the like.

### 7. Method of Mixing Raw Material Components

The method of mixing raw material components is not particularly limited but they may be mixed in a so-called batch-wise manner where individual raw material components are measured previously every mixing unit and they are then mixed together or in a so-called continuous manner where individual raw material components are continuously measured and mixed.

The mixing method for the batch-wise manner is not particularly limited but there may be specifically mentioned a method of charging one batch amount of individual raw material components into a Banbury mixer and mixing them.

The mixing method for the continuous manner is not particularly limited but there may be specifically mentioned a method of continuously measuring individual raw material components and feeding them to a molding machine such as an extruder so that the mixing ratio becomes constant every time and mixing them in the cylinder until the blend is discharged from the molding machine.

Moreover, in order to efficiently mix them, it is preferred to heat them at a temperature of 200 to 230° C. during mixing although the temperature is not particularly limited.

### 8. Method of Molding Molded Article

The method of molding a molded article comprising the above composite material composition is not particularly limited but examples thereof may include injection molding, extrusion molding, press molding, blow molding, and the like, which are methods used for molding usual resin materials.

### 9. Other Additives.

Additives such as a plasticizer, an antiaging agent, a colorant, a dispersant, and a flame retardant can be mixed with the composite material composition unless they impair the object of the invention.

According to the invention, there can be provided a composite material composition which secures a high-stiffness and also has a sufficient impact strength through increasing a mixing amount of an inorganic compound as well as a molded article comprising the composite material composition.

The invention provides a composite material composition comprising 50 to 95% by weight of a micro body of an inorganic compound, 0.1 to 30% by weight of a modified ethylene-butene copolymer rubber, and 1 to 48% by weight of a polypropylene resin.

### BRIEF DESCRIPTION OF THE DRAWINGS

FIG. 1 is a microscopic photograph of detail of Example of the molded article of the invention.

FIG. 2 is a microscopic photograph of a reflective electronic image of the same detail.

FIG. 3 is an explanatory drawing of a lower left part of the reflective electronic image of the same detail.

### DETAILED DESCRIPTION OF THE PREFERRED EMBODIMENTS

### Examples

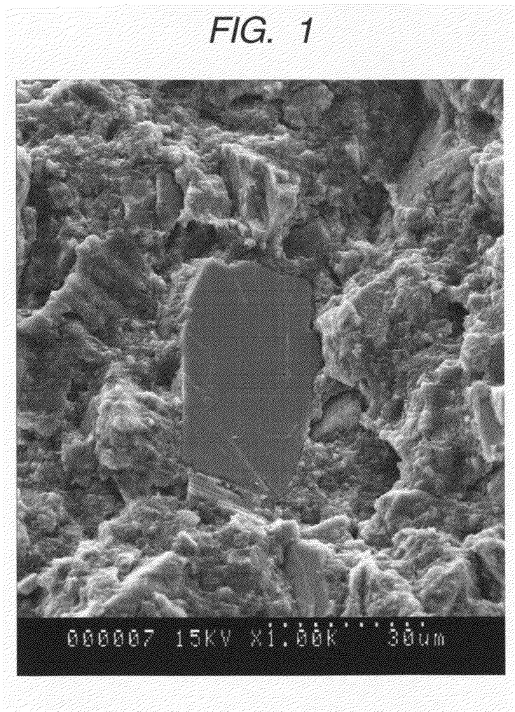

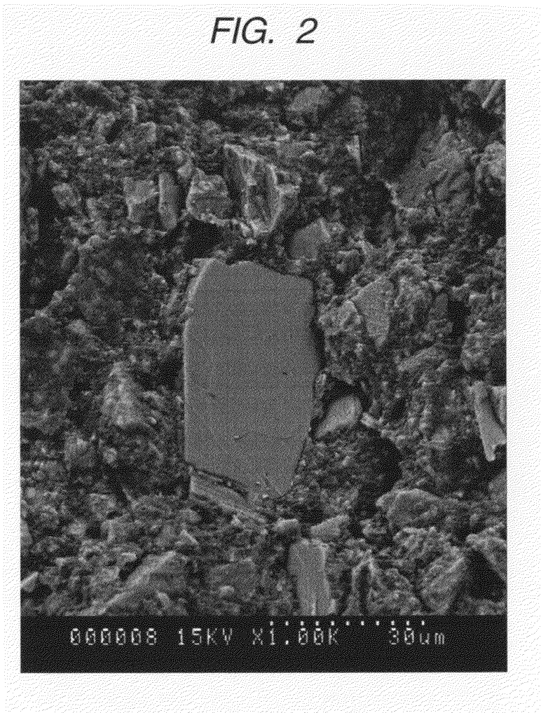

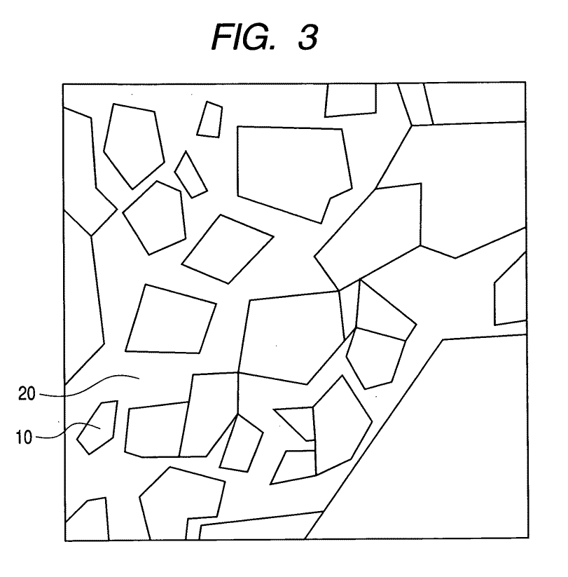

The composite material composition of the invention comprises a micro body of an inorganic compound, a modified ethylene-butene copolymer rubber, and a polypropylene resin, wherein, as shown in FIG. 1 to FIG. 3, the micro body 10 of the inorganic compound is surrounded by a mixture 20 of the modified ethylene-butene copolymer rubber and the polypropylene resin.

As Examples of the invention, test pieces for evaluation were prepared with 12 kinds of mixings shown in the following Table 1 and were evaluated. Moreover, test pieces for evaluation as Comparative Examples were prepared with 4 kinds of mixings and were also evaluated. In this connection, the unit of the mixing amount of each raw material component in the columns of the mixing content in Table 1 is “% by weight”.

TABLE 1

| | | Example 1 | Example 2 | Example 3 | Example 4 | Example 5 | Example 6 | Example 7 | Example 8 |
|---|---|---|---|---|---|---|---|---|---|
| Mixing | Calcium carbonate (calcium carbonate | 80 | 60 | 60 | 60 | 80 | 80 | 90 | |
| Content | heavy mfd. by Maruo Calcium Co., Ltd.) | | | | | | | | |
| | Talc (IMS 100 mfd. by Fuji Talc | | | | | | | | 60 |
| | Kogyosho K.K.) | | | | | | | | |
| | Wollastonite (NYGLOS M15 mfd. by | | | | | | | | |
| | NYCO MINERALS, INC) | | | | | | | | |
| | Mica (B-82 mfd. by Yamaguchi Mica Co., | | | | | | | | |
| | Ltd.) | | | | | | | | |
| | Maleic anhydride-modified ethylene- | 5 | 3 | 10 | 20 | 10 | 10 | 5 | 10 |
| | butane copolymer rubber (Toughmer | | | | | | | | |
| | MH7007 mfd. by Mitsui Chemicals Inc.) | | | | | | | | |
| | Maleic anhydride-modified polypropylene | | | | | | | | |
| | resin (PPMA6252 mfd. by Clariant | | | | | | | | |
| | Japan K.K.) | | | | | | | | |
| | Maleic anhydride-modified ethylene- | | | | | | | | |
| | propylene copolymer rubber (Toughmer | | | | | | | | |
| | MP0620 mfd. by Mitsui Chemicals Inc.) | | | | | | | | |
| | Polypropylene resin (BC06C mfd. by | 5 | 37 | 30 | 20 | 10 | 5 | 5 | 30 |
| | Japan Polypropylene Corp.) | | | | | | | | |
| | Alicyclic hydrocarbon resin (Arkon P70 | 10 | | | | | 5 | | |
| | mfd. by Arakawa Chemical Industries, | | | | | | | | |
| | Ltd.) | | | | | | | | |
| Test | Bending modulus (MPa) | 10000 | 1500 | 1500 | 1000 | 2000 | 6000 | 4000 | 5000 |
| result | IZOD impact strength (J/m) | 60 | 60 | 70 | 300 | 90 | 75 | 60 | 60 |
| | Surface appearance | ◯ | ◯ | ◯ | ◯ | ◯ | ◯ | ◯ | ◯ |
| | Injection moldability | ◯ | ◯ | ◯ | ◯ | ◯ | ◯ | ◯ | ◯ |
| | | | | | | Compara- | Compara- | Compara- | Compara- |
| | | | Example | Example | Example | tive | tive | tive | tive |
| | | Example 9 | 10 | 11 | 12 | Example 1 | Example 2 | Example 3 | Example 4 |
| Mixing | Calcium carbonate (calcium carbonate | | | 80 | 50 | 80 | 50 | 80 | 97 |
| Content | heavy mfd. by Maruo Calcium Co., Ltd.) | | | | | | | | |
| | Talc (IMS 100 mfd. by Fuji Talc | | | | | | | | |
| | Kogyosho K.K.) | | | | | | | | |
| | Wollastonite (NYGLOS M15 mfd. by | 60 | | | | | | | |
| | NYCO MINERALS, INC) | | | | | | | | |
| | Mica (B-82 mfd. by Yamaguchi Mica Co., | | 60 | | | | | | |
| | Ltd.) | | | | | | | | |
| | Maleic anhydride-modified ethylene- | 10 | 10 | 10 | 10 | | 50 | | 1 |
| | butane copolymer rubber (Toughmer | | | | | | | | |
| | MH7007 mfd. by Mitsui Chemicals Inc.) | | | | | | | | |
| | Maleic anhydride-modified polypropylene | | | 5 | | | | | |
| | resin (PPMA6252 mfd. by Clariant | | | | | | | | |
| | Japan K.K.) | | | | | | | | |
| | Maleic anhydride-modified ethylene- | | | | | | | 10 | |
| | propylene copolymer rubber (Toughmer | | | | | | | | |
| | MP0620 mfd. by Mitsui Chemicals Inc.) | | | | | | | | |
| | Polypropylene resin (BC06C mfd. by | 30 | 30 | 5 | 40 | 20 | | 10 | 2 |
| | Japan Polypropylene Corp.) | | | | | | | | |
| | Alicyclic hydrocarbon resin (Arkon P70 | | | | | | | | |
| | mfd. by Arakawa Chemical Industries, | | | | | | | | |
| | Ltd.) | | | | | | | | |
| Test | Bending modulus (MPa) | 5000 | 4500 | 3000 | 1200 | 5600 | 300 | 3000 | 2000 |
| result | IZOD impact strength (J/m) | 60 | 65 | 80 | 80 | 25 | 300 | 20 | 25 |
| | Surface appearance | ◯ | ◯ | ◯ | ◯ | X | ◯ | X | X |
| | Injection moldability | ◯ | ◯ | ◯ | ◯ | ◯ | X | ◯ | X |

As the raw material components used in Examples and Comparative Examples, trade name “calcium carbonate heavy” of Maruo Calcium Co., Ltd. was used as calcium carbonate, trade name “LS 100” of Fuji Talc Kogyosho K.K. as talc, trade name “NYGLOS M15” of NYCO MINERAL, INC. as wollastonite, and trade name “B-82” of Yamaguchi Mica Co., Ltd. as mica.

Trade name “Toughmer MH7007” of Mitsui Chemicals Inc. was used as a maleic anhydride-modified ethylene-butene copolymer rubber, trade name “PPMA6252” of Clariant Japan K.K. as a maleic anhydride-modified polypropylene resin, and trade name “Toughmer MP0620” of Mitsui Chemicals Inc. as a maleic anhydride-modified ethylene-propylene copolymer rubber.

Trade name “BC06C” (MFR: 60 g/10 minutes at 230° C., 2.16 kgf (21.18N)) of Japan Polypropylene Corp. was used as a polypropylene resin and trade name “Arkon P70” of Arakawa Chemical Industries, Inc. as an alicyclic hydrocarbon resin.

A test piece to be used in each evaluation was mixed and molded as follows.

Using a 80-tons injection molding machine where temperature of the cylinder was set at 230° C., individual raw material components were measured and charged from a hopper located at a terminal edge of the cylinder so that the mixing ratio became constant each time and, after they were mixed by rotating screws in the cylinder, the mixed product was injected into a mold heated at a mold temperature of 40° C., thereby molding being effected.

### (1) Test of Bending Modulus

In order to measure bending modulus, a test was conducted in accordance with ISO-178.

### (2) Test of IZOD Impact Strength

In order to measure IZOD impact strength, a test was conducted in accordance with ISO 180.

### (3) Test of Surface Appearance

Under the above molding conditions, a square test piece having a thickness of 2 mm and a side length of 70 mm was molded and surface conditions of the test piece was visually observed and evaluated.

As evaluation results, ◯ represents good appearance and x represents bad appearance.

### (4) Test of Injection Moldability

Residential stability, flowability, and the like of each sample at molding were evaluated in the case where molding was conducted under the above conditions.

As evaluation results, ◯ represents the case where molding is achieved without any problems on residential stability, flowability, and the like, and x shows the case where problem(s) such as insufficient flowability, bad metering, and/or the like arise.

From the above results, the molded articles of the present Examples secure a high stiffness and also have a sufficient impact strength. Moreover, injection molding can be achieved without troubles and also appearance of the molded articles is good. The results are attributable to the following reasons:

the high stiffness is attributable to the use of an inorganic compound as a matrix (high filling);

the high impact strength is attributable to the fact that, when stress is imparted, a mixture of the modified ethylene-butene copolymer rubber and the polypropylene resin and the like relieves the stress; and

the good moldability is attributable to the fact that the modified ethylene-butene copolymer rubber and the like in the mixture of the modified ethylene-butene copolymer rubber and the polypropylene resin and the like increases affinity of the micro body of the inorganic compound to the mixture and hence the polypropylene resin and the like in the mixture slides the micro body of the inorganic compound.

Furthermore, by incorporating a larger amount of the inorganic compound, a product having a high dimensional stability (ultra-low linear expansion) was formed.

Incidentally, the invention is not limited to the above. Examples and can be specified with suitably changing them without departing from the gist of the invention.

What is claimed is:

1. A composite material composition comprising:
50 to 95% by weight of a micro body of an inorganic compound,
0.1 to 30% by weight of a modified ethylene-butene copolymer rubber that is an unsaturated dicarboxylic acid-modified ethylene-butene copolymer rubber or an unsaturated dicarboxylic acid anhydride-modified ethylene-butene copolymer rubber, and
1 to 48% by weight of a polypropylene resin.

2. The composite material composition according to claim 1, wherein the inorganic compound is at least one of calcium carbonate, talc, mica, and wollastonite.

3. The composite material composition according to claim 1, wherein length of the longest part of the micro body of the inorganic compound is 90 μm or less.

4. The composite material composition according to claim 1, wherein the modified ethylene-butene copolymer rubber is a maleic anhydride-modified ethylene-butene copolymer rubber.

5. The composite material composition according to claim 1, further comprising an alicyclic hydrocarbon resin.

6. The composite material composition according to claim 1, further comprising 0.1 to 20% by weight of an alicyclic hydrocarbon resin.

7. The composite material composition according to claim 1, further comprising a modified polypropylene resin that is an unsaturated dicarboxylic acid-modified polypropylene resin or an unsaturated dicarboxylic acid anhydride-modified polypropylene resin.

8. The composite material composition according to claim 7, wherein the modified polypropylene resin is the unsaturated dicarboxylic acid anhydride-modified polypropylene resin.

9. The composite material composition according to claim 8, wherein the unsaturated dicarboxylic acid anhydride-modified polypropylene resin is a maleic anhydride-modified propylene resin.

10. The composite material composition according to claim 1, further comprising 0.1 to 10% by weight of a modified polypropylene resin.

11. A molded article comprising the composite material composition according to claim 1.

12. A composite material composition comprising:
50 to 95% by weight of a micro body of an inorganic compound that is at least one of calcium carbonate, talc, mica, and wollastonite and length of the longest part of which is 90 μm or less, 0.1 to 30% by weight of a modified ethylene-butene copolymer rubber that is a maleic anhydride-modified ethylene-butene copolymer rubber,
1 to 48% by weight of a polypropylene resin,
0.1 to 20% by weight of an alicyclic hydrocarbon resin
0.1 to 10% by weight of a maleic anhydride-modified propylene resin.
